(19) United States
(12) Patent Application Publication
(10) Pub. No.: US 2026/0335048 A1
(43) Pub. Date: Oct. 29, 2026

(54) ORTHODONTIC ALIGNER BRACKET AND SYSTEM COMPRISING SAME

(71) Applicant: THE BOARD OF REGENTS OF THE NEVADA SYSTEM OF HIGHER EDUCATION ON BEHALF OF THE UNIVERSITYL, Las Vegas, NV (US)

(72) Inventors: James MAH, Las Vegas, NV (US); Kory GRAHL, Las Vegas, NV (US)

(21) Appl. No.: 19/107,918

(22) PCT Filed: Aug. 31, 2023
(86) PCT No.: PCT/US2023/031677

§ 371 Date: Feb. 28, 2025

Related U.S. Application Data
(60) Provisional application No. 63/402,680, filed on Aug. 31, 2022.

(51) Int. Cl. A61C 7/30; A61C 7/20

(52) U.S. Cl. CPC A61C 7/303; A61C 7/20

(57) ABSTRACT

A bracket for orthodontic use can be configured to couple to a tooth. The bracket can have a fixation side and an opposed outward side that are spaced along a first axis. The bracket can comprise opposed prongs that are spaced along a vertical axis that is perpendicular to the first axis. The opposed prongs can cooperate to define a slot therebetween. The slot can extend along a horizontal axis that is perpendicular to the first axis and the vertical axis. The slot can define a taper in a first direction from the outward side of the bracket to the fixation side of the bracket. The opposed prongs can each have an outer surface opposite the slot. The bracket can be configured for use with a wire or for an aligner.

### CROSS-REFERENCE TO RELATED APPLICATION

This application claims priority to, and the benefit of the filing date of, U.S. Provisional Patent Application No. 63/402,680, filed Aug. 31, 2022, the entirety of which is hereby incorporated by reference herein.

### FIELD

This disclosure relates to orthodontic aligners.

### BACKGROUND

Two types of orthodontic aligners dominate the industry. A first type is traditional wired braces. Braces are attached to outer surfaces of one or more teeth, and include brackets that each have a rectangular slot. A wire is received within the rectangular slot. The wire is either round or rectangular. A rectangular wire is used to apply torque to the tooth. A second type of orthodontic aligner uses a progressive, clear removable structure. With these aligners, an orthodontist forms attachments (bumps) by hand on the tooth, and the progressive, clear removable aligner cooperates with the bumps to move the teeth.

Each of these methods has advantages and drawbacks. Traditional wired braces are highly visible and are often deemed aesthetically unpleasing to the wearer, but are relatively effective. Progressive, clear removable aligners are less noticeable and can be aesthetically preferred, but they commonly do not perform as well as traditional wired braces. Thus, conventionally, the wearer has to choose between aesthetics and performance.

Further, the attachments for progressive, clear removable aligners are made of a non-durable material that can wear down over time. Moreover, because the attachments are hand-formed, they can be subject to imperfections, such as under- or over-filling receptacles that are used to form the attachments.

Brackets for traditional wire braces have a rectangular slot to receive the wire. Due to machine tolerances, these rectangular slots are oversized, leading to “slop” between the wire and the bracket. This slop can hinder performance, such as a reduction of torque on the brace.

### SUMMARY

Described herein, in various aspects, is an orthodontic bracket that is configured to couple to a tooth. The bracket can have a fixation side and an opposed outward side that are spaced along a first axis. The bracket can comprise opposed prongs that are spaced along a vertical axis that is perpendicular to the first axis. The opposed prongs can cooperate to define a slot therebetween. The slot can extend along a horizontal axis that is perpendicular to the first axis and the vertical axis. The slot can define a taper in a first direction from the outward side of the bracket to the fixation side of the bracket. The opposed prongs can each have an outer surface opposite the slot. The bracket can be configured for use with a wire or for an aligner.

In one aspect, a system can comprise a bracket as disclosed herein and a wire that is configured to be coupled thereto.

In one aspect, a system can comprise a bracket as disclosed herein and an aligner that is configured to be coupled thereto.

Methods of using the systems are also disclosed.

### DESCRIPTION OF THE DRAWINGS

FIG. 1 shows a tooth having an exemplary bracket coupled thereto.

FIG. 2 shows a side view of the bracket of FIG. 1.

FIG. 3 shows a side view of the bracket of FIG. 1, with a pair of round wires received within a slot of the bracket.

FIG. 4 shows a side view of the bracket of FIG. 1, with a trapezoidal wire received within the slot.

FIG. 5 shows a side view of the bracket of FIG. 1, with an aligner coupled thereto.

FIG. 6 shows an exemplary bracket as disclosed herein.

FIG. 7 shows a sectional view of the exemplary bracket of FIG. 6, taken in the plane 7-7 of FIG. 6.

FIG. 8 shows a sectional view of the exemplary bracket of FIG. 6, taken in the plane 8-8 of FIG. 6.

FIG. 9 shows a sectional view of the exemplary bracket of FIG. 6, taken in the plane 9-9 of FIG. 6.

FIG. 10 shows an exemplary bracket as disclosed herein.

FIG. 11 shows a sectional view of the exemplary bracket of FIG. 10, taken in the plane 11-11 of FIG. 10.

FIG. 12 shows a sectional view of the exemplary bracket of FIG. 10, taken in the plane 12-12 of FIG. 10.

FIG. 13 shows a sectional view of the exemplary bracket of FIG. 10, taken in the plane 13-13 of FIG. 10.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a bracket” can refer to one or more of such brackets.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “approximately,” “substantially,” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

As used herein, the term “torque” should be interpreted as those skilled in the art of orthodontics would understand in the context of its use in orthodontics.

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

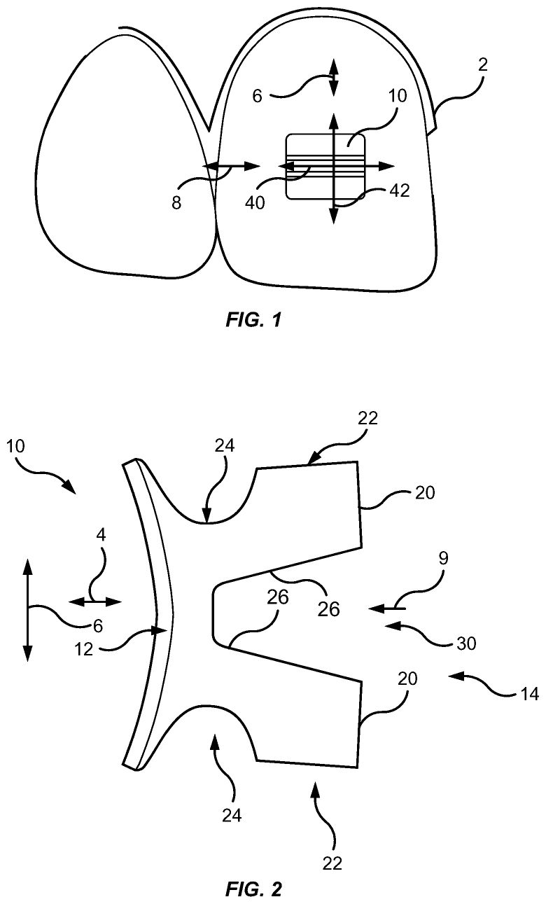

Disclosed herein, and with reference to FIGS. 1-3, is a bracket 10 that is configured to couple to a tooth 2. The bracket 10 can have a fixation side 12 and an opposed outward side 14 that are spaced along a first axis 4. The fixation side 12 can optionally have a surface with a contour that is complementary or substantially complementary to a tooth. For example, the fixation side 12 can have a concave surface. As illustrated in FIGS. 8 and 9, in some aspects, the fixation side 12 can be concave in horizontal planes and in vertical planes. For example, a cross section of the fixation side can have a radius of from about 0.75 to about 1 inch (e.g., about 0.915 inches) in a vertical plane, and a cross section of the fixation side can have a radius of from about 0.4 to about 0.75 inch (e.g., about 0.55 inches) in a horizontal plane. Optionally, the fixation side 12 can be textured (e.g., having bumps, ridges, or grooves 60, as shown in FIG. 8) to provide spaces for adhesive to bond the bracket 10 to the tooth 2. In some optional aspects, the fixation side 12 can be customized for a particular tooth of a particular patient based on, for example, a mold or intra-oral imaging.

The bracket 10 can comprise opposed prongs 20 that are spaced along a vertical axis 6 that is perpendicular to the first axis 4. The opposed prongs 20 can cooperate to define a slot 30 therebetween. The slot 30 can extend along a horizontal axis 8 that is perpendicular to the first axis 4 and the vertical axis 6. (It should be understood that “horizontal” and “vertical” are shown with reference to the orientation shown in FIG. 1, which generally corresponds to the orientation of the brackets when a user has normal head posture. In use, the brackets 10 can be coupled to the tooth in any orientation, so these axes need not be horizontal and vertical.) The slot 30 can define a taper in a first direction 9 from the outward side 14 of the bracket 10 to the fixation side 12 of the bracket. The opposed prongs 20 can each have an outer surface 22 opposite the slot 30.

In some aspects, the taper of the groove 30 can have an angle of greater than 5 degrees. In further aspects, the taper of the groove 30 can have an angle of greater than 10 degrees. In some optional aspects, the taper of the groove 30 can have an angle from about 5 degrees to about 15 degrees. In some aspects, the taper can have an angle of about 10 degrees. In still further aspects, the taper can have an angle of up to 5 degrees to 65 degrees, or from 30 degrees to 50 degrees, or about 45 degrees. For example, inner surfaces 26 of the opposed prongs 20 can optionally be planar, and the inner surfaces can converge at a 10 degree angle along the first axis 4. In other aspects, the inner surfaces 26 can be concave (toward the slot 30) or convex (toward the slot). The slot 30 can have a depth along the first axis 4. In some aspects, the taper can be continuous along at least 70% of an entire depth of the slot 30, at least 80% of an entire depth of the slot, at least 90% of the entire depth of the slot, or all or substantially all of the entire depth of the slot.

In exemplary, optional aspects, the depth, d, of the slot 30 can be from about 0.025 inches to about 0.08 inches, or from 0.03 inches to about 0.06 inches, or about 0.054 inches. In some aspects, the slot can have a depth from about 0.025 inches to about 0.045 inches, or about 0.035 inches. Optionally, the slot 30 can have a minimum width, w, along the vertical axis 6 of less than 0.016 inches, or from about 0.01 inches to about 0.02 inches, or from about 0.012 inches to about 0.016 inches, or about 0.014 inches, or about 0.018 inches.

In exemplary aspects, the slot 30 can have a minimum width, w, from about 0.014 inches to about 0.018 inches. In exemplary aspects, the slot 30 can have a maximum width from about 0.040 inches to about 0.060 inches. In still further aspects, the slot 30 can have any combination of a minimum width of 0.014 inches and a maximum width of 0.040 inches, 0.050 inches, or 0.060 inches, or a minimum width of 0.018 inches and a maximum width of 0.040 inches, 0.050 inches, or 0.060 inches. In other aspects, the slot can have a maximum width and a maximum width in between any of the above combinations. Optionally, in these aspects, the slot can have a depth of about 0.035 inches.

The bracket 10 can have a width along the horizontal axis 8. In some optional aspects, the prongs 20 can extend an entire length of the bracket. In some optional aspects, the bracket can have exactly two prongs (an upper prong and a lower prong). In other aspects, the bracket 10 can comprise multiple prongs above the slot and/or multiple prongs below the slot (optionally, an equal number of prongs above the slot and below the slot). For example, the bracket can comprise two upper prongs and two lower prongs. In further aspects, the brackets can comprise three upper prongs and three lower prongs.

In some optional aspect, the bracket 10 can be symmetric about a horizontal plane 40 that bisects the bracket and is parallel to or contains the horizontal axis 8 and the first axis 4.

In some optional aspect, the bracket 10 can be symmetric about a vertical plane 42 that bisects the bracket and is parallel to or contains the vertical axis 6 and the first axis 4.

In some aspects, the outer surface 22 of each prong 20 can define a groove 24 that is configured to receive a portion of a band (e.g., an elastic band or metal tie). In this way, as further described herein, the band can couple a wire to the bracket 10. In some optional aspects, the grooves 24 can be arcuate in planes perpendicular to the horizontal axis 8. For example, the grooves 24 can have surfaces that are complementary to conventional elastic bands for braces having round cross sections.

In some optional aspects, the outer surfaces 22 of the opposed prongs 20 can converge in the first direction 9. For example, in some aspects, at least portions of the outer surfaces can be planar, and planes that include the planar portions of the outer surfaces can intersect. Optionally, the outer surfaces of the opposed prongs converge in the first direction at an angle from about 1 degree to about 15 degrees, or from about 2 degrees to about 15 degrees, or from about 2 degrees to about 10 degrees, or from about 4 degrees to about 10 degrees, or from about 2 degrees to about 4 degrees, or from about 10 degrees to about 15 degrees, or about 4 degrees. For example, planes that include the planar portions of the outer surfaces can intersect at an angle from about 2 degrees to about 10 degrees, or at least 3 degrees, or about 4 degrees. In some aspects, planes that are tangential to the outer surfaces 22 can converge in the first direction 9. Said planes can converge in the first direction at an angle from about 2 degrees to about 10 degrees, or about 4 degrees. The planes that are tangential to the outer surfaces can each intersect the horizontal plane 40 at respective angles from 1 degree to 5 degrees, or about 2 degrees.

The convergence of the opposed prongs 20 can permit an aligner 150 to couple to the bracket 10, as further described herein.

In some aspects, the bracket 10 can comprise ceramic material. Accordingly, in some aspects, the bracket 10 can be white or off-white. In some aspects, the bracket 10 can be tooth-colored. In some aspects, the bracket can be made to have a color that matches a tooth color of a particular user. In some optional aspects, the bracket 10 can be 3D printed. The brackets 10 can, thus be precision-made, unlike hand-made bump brackets that are conventionally used with conventional progressive, clear removable aligners.

A system 100 can comprise at least one bracket 10 and a wire 110 configured to be received within the slot 30.

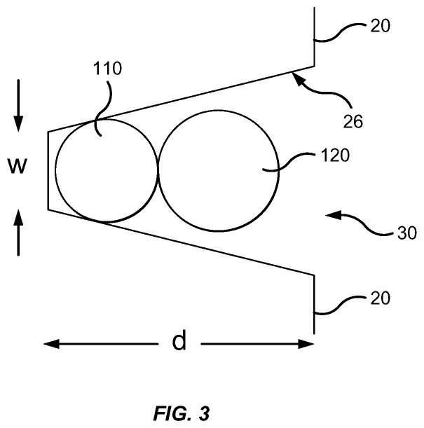

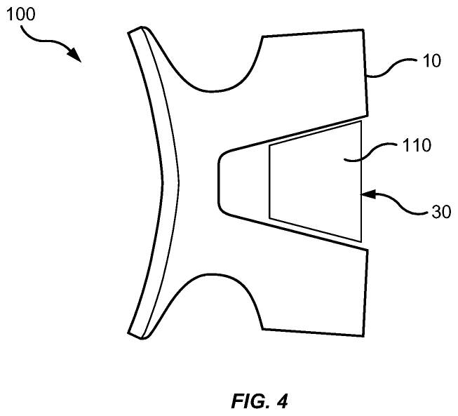

Referring to FIGS. 3 and 4, the wire 110 can have a dimension of elongation. As illustrated in FIG. 4, in some optional aspects, the wire 110 can be trapezoidal in cross sections perpendicular to the dimension of elongation. The wire 110 can optionally have a profile (e.g., a cross sectional profile) that is complementary to the slot 30. The wire can be configured to be complementarily received within the slot 30 of the bracket 10.

In alternative aspects, the wire 110 can be circular in cross sections perpendicular to the dimension of elongation.

The wire 110 can be configured to be wedged within the slot. When the wire 110 is received within the slot, the wire can be wedged therein. Wedging of the wire 110 within the slot can permit controlled binding between the wire and bracket. In this way, relative movement between the wire and the bracket can be inhibited. For example, the bracket can be inhibited from sliding along the wire. This can be advantageous for controlling and preventing sliding of the wire within the slot depending on the forces applied to the tooth by the wire. Prevention of sliding of the wire within the slot can be advantageous to avoid unintended movement of teeth.

Referring to FIG. 3, in some aspects, the wire 110 can be a first wire, and the system 10 can further comprise a second wire 120 that is configured to be received within the slot. For example, the first and second wires can have circular cross sections perpendicular to their dimension of elongation. The first wire 110 can have a first cross sectional dimension (e.g., diameter). In some optional aspects, second wire 120 can have a second cross sectional dimension (e.g., diameter) that is greater than the first cross sectional dimension. When the first and second wires are received within the slot 30, the first wire 110 can be positioned inwardly of the second wire 120. In this way, the first wire 110 can inhibit the second wire 120 from wedging within the slot 30. Thus, the bracket 10 can be permitted to move relative to (e.g., along the dimension of elongation of) the second wire 120. Optionally, depending on the particular wire sizes that are selected, at least a portion of the second wire 120 can extend out of the slot—that is, the entirety of the second wire 120 can be received within the slot, but if the sizes of the first and/or second wires are too large, it is contemplated that a portion of the second wire 120 can extend outward of the slot.

In some aspects, the first and second wires 110, 120 can have circular cross sections, and the first and second cross sectional dimensions can be diameters. Thus, for example, the first wire can have a diameter of 0.016 inches, and the second wire can have a diameter of 0.018 inches. In other aspects, the first and second wires 110, 120 can have trapezoidal, rectangular, or square cross sections, and the first and second dimensions can be respective diagonals.

In some aspects, the wire 110 can be configured to apply torque to the bracket. For example, with the wire 110 received within the bracket 10, the wire 110 can apply forces to the inner surfaces 26 of the prongs 20 to apply a torque about an axis that is parallel to the horizontal axis 8.

In some aspects, the first and second wires 110, 120 can be welded or otherwise rigidly coupled to one another. This can be done, for example, to provide added rigidity to the wires. In another aspect, the first or second wires 110, 120 can be twisted or otherwise bent and coupled (e.g., welded) together in a twisted or bent configuration. For example, wire 120 can be twisted along the vertical axis in FIG. 3 and held in a twisted position, and the first wire 110 can be welded to the second wire 120 in a first circumferential position (e.g., a 12 O'clock position). Upon release of twist from the second wire 120, the second wire 120 can return to the pre-twisted configuration (e.g., to a 9 O'clock position), thereby carrying the wire 110, via weldment, to a new position. The engagement of the coupled first and second wires 110, 120 into the slot can impart tooth movement forces such as torque.

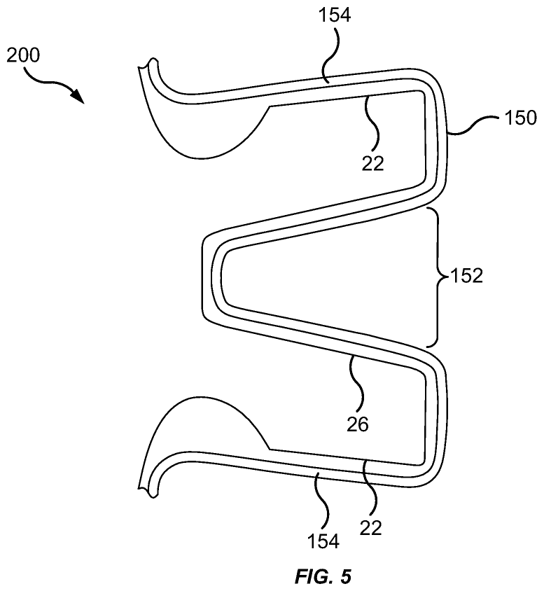

Referring to FIG. 5, a system 200 can comprise one or more brackets 10 and an aligner 150 that is configured to be coupled to the one or more brackets. In some aspects, the aligner 150 can be clear (e.g., transparent).

In some optional aspects, the aligner 150 can be thermoformed to each bracket 10. For example, the aligner 150 can be heated to form around the outer surfaces 22 of the prongs 20 of the bracket 10. In this way, a tight fit between the aligner 150 and the bracket 10 can be formed. In some optional aspects, the aligner 150 can be 3D printed or otherwise formed to complementarily receive and form a tight fit with each bracket 10. The spacing between the aligner and the bracket 10 in FIG. 5 is provided to show the geometry of each component. In use, it is contemplated that the aligner 150 and bracket are in contact.

In some aspects, the aligner 150 can comprise inner surfaces 152 that are configured to be received within the slot. The inner surfaces 152 of the aligner 150 that are configured to be received within the slot 30 can be configured to apply a torque to the bracket 10. For example, with the inner surfaces 152 of the aligner 150 received within the slot 30, the inner surfaces 150 can bias against the inner surfaces 26 of the prongs 20 to apply a torque to the bracket and, thus, the tooth.

In aspects in which the outer surfaces 22 of the opposed prongs 20 of the bracket 10 converge in the first direction 9, the aligner 150 can comprise surfaces 154 that bias against the outer surfaces 22 of the opposed prongs 20 to couple the aligner 150 to the bracket.

A method can include positioning an aligner on a bracket 10 as disclosed herein.

In some aspects, a method can include positioning a wire 110 within a slot 30 of a bracket 10. The method can further comprise securing the wire 110 within the slot 30 with a band, such as, for example, an elastic band or a metal tie.

It is contemplated that the brackets can be used interchangeably with either a wire 110 or an aligner 150. For example, a method can comprise removing a wire 110 from the slot 30 of the bracket prior to positioning the aligner on the bracket. Similarly, a method can comprise removing an aligner 150 from the bracket 10 prior to positioning the wire 110 within the slot 30.

The brackets 10 and systems disclosed herein provide various advantages over orthodontic aligners as conventionally used. For example the brackets 10 can be used interchangeably with both clear aligners and wires—that is, the same brackets 10 are compatible with both clear aligners and wires. Accordingly, the user can receive the advantages of wires (e.g., more effective alignment) as well as the advantages of clear aligners (e.g., being less visible). The user can, for example, use the brackets with an aligner for a wedding or other event and use the brackets with a wire, or plurality of wires, when the aesthetics are deemed less important.

Further, the disclosed brackets 10 can work advantageously with an aligner. For example, receipt of the inner surfaces 152 of the aligner within the slot can provide torque that is generally unavailable with conventional braces.

Advantageously, the taper of the slot 30 can provide a good fit between the wire and the bracket 10. Unlike conventional rectangular slots, the wire can move inwardly into the slot to provide a tight fit with the wire, thereby reducing slop and optimizing ability to provide torque. A trapezoidal wire can be complementarily received within the tapered slot to provide advantageous torque with minimal slop. Further, the taper of the slot can permit binding between the wire and bracket may be controlled. This can contrast to conventional braces that do not permit good binding.

Optionally, the disclosed brackets can be provided as components of a kit, which can also include an aligner and/or at least one wire (optionally, a plurality of wires) as further disclosed herein. For example, a kit can comprise a plurality of brackets and an aligner, which can optionally be provided together in packaging. As another example, a kit can comprise a plurality of brackets and at least one wire, which can optionally be provided together in packaging.

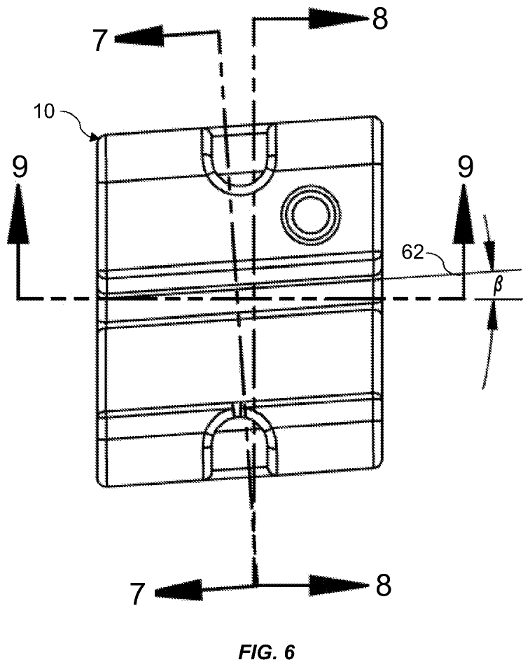

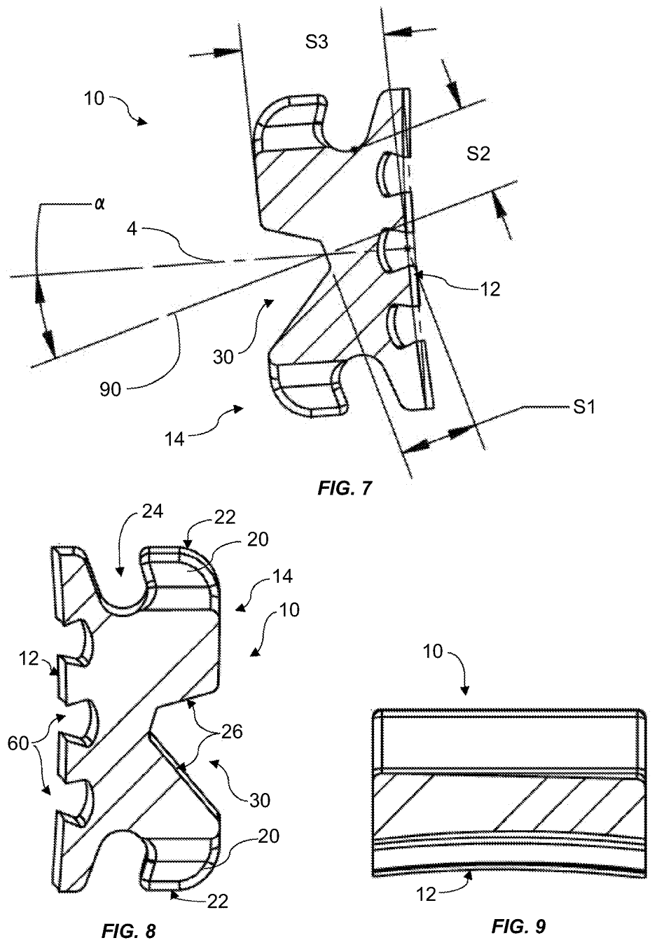

Referring to FIGS. 6 and 7, in some aspects, the slot can extend parallel to the first axis 4. In other aspects, the slot can extend at an acute angle relative to the first axis 4. For example, a plane 90 that bisects the inner surfaces 26 can intersect the first axis 4 at an acute angle. The acute angle can define a torque angle α. In some aspects, the torque angle α can be from about 0 to about 45 degrees, or from about 5 to about 30 degrees, of from about 10 to about 25 degrees, or from about 15 to about 20 degrees.

In some aspects, the bracket 10 can comprise an orientation indicator. For example, the bracket 10 can have a frustoconical recess that indicates rotational orientation of the bracket.

The bracket 10 can have a relief between the left and right sides on the top and bottom of the bracket to permit receipt of an elastic removal instrument for lifting the elastic band off the bracket.

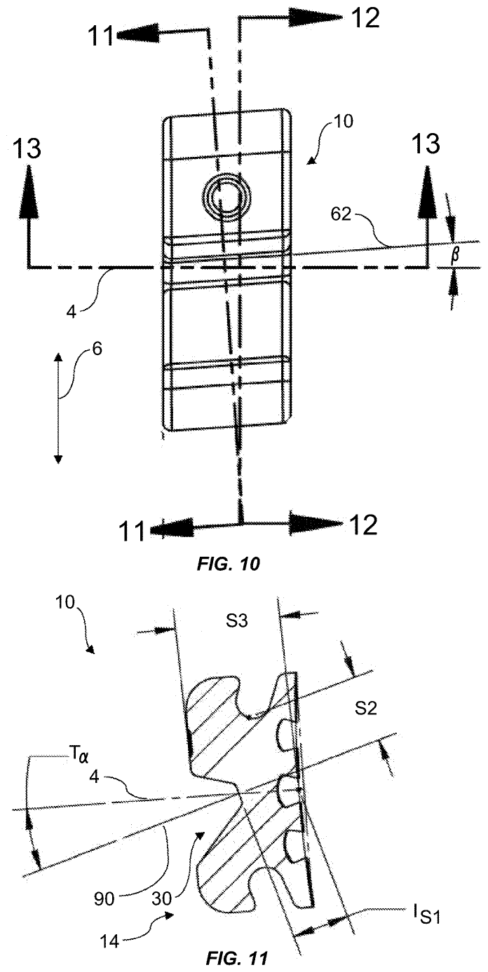

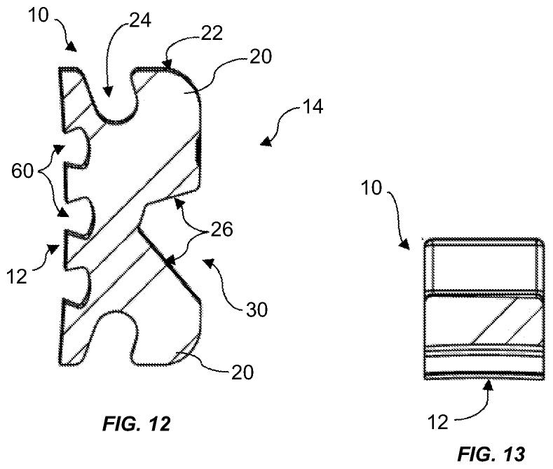

Referring to FIGS. 6 and 10, in some aspects, the bracket 10 can be a full bracket (FIG. 6). For example, the full bracket can have a width along the horizontal axis 8 of about 0.125 inches and a height of about 0.154 inches along the vertical axis 6. In other aspects, the bracket 10 can be a half-bracket (FIG. 10). For example, the half bracket can have a width along the horizontal axis 8 of about 0.063 inches and a height of about 0.154 inches along the vertical axis 6. Use of a full bracket or a half bracket can be determined by the biomechanics of tooth movement. For example a full bracket can be advantageous to correct a rotation by providing a mechanical advantage due to its width. For intrusion or extrusion of a tooth a smaller half bracket can be sufficient and can be preferable for aesthetic purposes.

Referring to FIGS. 7 and 11, in some optional aspects, the bracket 10 can have spacing S1 between the fixation side 12 and the slot 30 of about 0.038 inches. In some optional aspects, the bracket 10 can have spacing S2 between the groove 24 and the slot 30 of about 0.042 inches. In some optional aspects, the bracket 10 can have spacing S3 between the fixation side 12 and the opposite side of the bracket of about 0.069 inches.

In some aspects, the bracket 10 can be symmetric about a plane that bisects the bracket and is parallel to the first and vertical axes 4, 6. In other aspects, the bracket 10 can be asymmetric about the plane that bisects the bracket and is parallel to the first and vertical axes 4, 6. For example, as illustrated in FIGS. 6 and 10, the outer surfaces 22 (e.g., upper and lower surfaces) of the bracket 10 can both slope upwardly from left-to-right, or both slope upwardly from right-to-left along the horizontal axis 8. In some aspects, a bracket having outer surfaces 22 that both slope upwardly from left-to-right (looking in the first direction 9) can advantageously be used on teeth on the left side of the patient, and bracket having outer surfaces 22 that both slope upwardly from right-to-left can advantageously be used on teeth on the left side of the patient. Optionally, in these aspects, outer surfaces of the bracket can be rotationally symmetric about an axis parallel to the first axis 4. In exemplary aspects, the left-to-right or right-to-left slope can form an angle, β, with the horizontal axis 4 of between 0 and 15 degrees, or between 0 and 10 degrees, or about 4 degrees. Optionally, in these aspects, the slot 30 can extend along an axis 62 that forms the angle β with the first axis 4.

### Example Embodiments

A plurality of exemplary brackets with different slot dimensions were tested to characterize retentive force between each bracket and an aligner 152 (FIG. 5). The slot dimensions tested were a minimum width of 0.014 inches combined with maximum widths of 0.040 inches, 0.050 inches, and 0.060 inches; and a minimum width of 0.018 inches combined with maximum widths of 0.040 inches, 0.050 inches.

The mean force in pounds (lbs) of the seventy (70) trials were measured from each configuration. Standard deviations were calculated to evaluate the amount of variation or dispersion of the force required to remove the aligner from the model in the fourteen (14) day, removing five (5) times per day, aligners wear model. The highest mean force was found in the 0.018″×0.060″ trapezoidal slot group, which had a mean of 5.77 lbs of peak force. The lowest mean force was found in the 0.014″×0.050″ trapezoidal slot group, which had a mean of 3.19 lbs of peak force. The highest standard deviation was found in the 0.018″×0.050″ trapezoidal slot group, which had a standard deviation of 0.97. The lowest standard deviation was found in the 014×050 trapezoidal slot group, which had a standard deviation of 0.35. The current aligner market 2 mm horizontal bevel retention attachment had a mean peak force of 3.60 lbs+/−0.70 which was very similar to the 0.014″×0.060″ trapezoidal slot group which had a mean peak force of 3.50 lbs.+/−0.73. The no attachment and traditional 2 mm horizontal bevel attachment groups were considered controls within the experiment as they are currently being used on the orthodontic market. Table 1 (below) summarizes the mean force of the different slot configurations.

TABLE 1
Mean Force for Exemplary Slot Configurations

| Slot Configurations | Mean Force (lbs.) | Standard Deviation |
|---|---|---|
| 014_040 | 3.22 | 0.45 |
| 014_050 | 3.19 | 0.35 |
| 014_060 | 3.50 | 0.73 |
| 018_040 | 3.76 | 0.70 |
| 018_050 | 3.59 | 0.97 |
| 018_060 | 5.77 | 0.62 |
| 2 mm Attachment | 3.60 | 0.69 |
| No Attachment | 4.37 | 0.52 |

Paired two-tail t-tests were calculated between all different categories with a clinical significance value set at p=0.05. Tests were calculated to statistical significance between base of trapezoidal slot (014 and 018), top of trapezoidal slot (040, 050, 060), no attachment, and 2 mm traditional retention attachment. The no attachment and traditional 2 mm horizontal bevel attachment groups were considered controls within the experiment as they are currently being used on the orthodontic market. In the top of slot group with 014 base, statistical significance was discovered between the 040 vs. 060 and 050 vs. 060 groups. The top of slots group with 018 base also demonstrated statistical significance between the 040 vs. 060 and 050 vs. 060 group. The 014 base and 018 base groups vs. no attachment control group, all top of slot dimensions displayed statistical significance. The 014 base group vs. 2 mm attachment displayed clinical significance in the 040 and 050 top of slot but not in the 060 group. The 018 base group vs. 2 mm attachment group also displayed statistical significance in the 040 and 050 top of slot groups, but not the 060 top of slot group. Lastly, top of slot groups were compared against base of slot, and statistical significance was seen in the 040, 050, and 060 top of slot group. Further, there was statistical significance demonstrated between the 2 mm retention attachment and the no attachment groups. Table 2 (below) includes a summary of the above-described T-Tests.

TABLE 2
T-TESTS

| | | | |
|---|---|---|---|
| 014 | 040 vs. 050 | 040 vs. 060 | 050 vs. 060 |
| | 0.6419221 | 0.0081533 | 0.0020173 |
| | p = 0.642 | p = 0.008 | p = 0.002 |
| 018 | 040 vs. 050 | 040 vs. 060 | 050 vs. 060 |
| | 0.2390997 | 1.11E−37 | 9.88E−31 |
| | p = 0.239 | p = 0.000 | p = 0.000 |
| No Attachment vs. | 018040 | 018050 | 018_060 |
| 018 | 4.78E−08 | 5.06−E08 | 2.28E−29 |
| | p = 0.000 | p = 0.000 | p = 0.000 |
| 2 mm Traditional | 018_040 | 018_050 | 018_060 |
| Retention | 0.1595648 | 0.9802663 | 1.48E−41 |
| Attachment vs. 018 | p = 0.156 | p = 0.980 | p = 0.00 |
| No Attachment vs. | 014_040 | 014_050 | 014_060 |
| 014 | 3.44E−28 | 3.48E−31 | 2.97E−13 |
| | p = 0.000 | p = 0.000 | p = 0.000 |
| 2 mm Traditional | 014_040 | 014_050 | 014_060 |
| Retention | 0.0002217 | 0.0000282 | 0.4071911 |
| Attachment vs. 014 | p = 0.0002 | p = 0.00002 | p = 0.407 |
| 040 | 014 vs. 018 | | 014 vs. 018 |
| | 0.0000003 | 060 | 5.83E−42 |
| | p = 0.000 | | p = 0.000 |
| 050 | 014 vs. 018 | 2 mm Traditional | No Attachment |
| | 0.00166137 | Retention | 1.00E−11 |
| | p = 0.002 | Attachment | p = 0.000 |

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A bracket that is configured to couple to a tooth, the bracket having a fixation side and an opposed outward side that are spaced along a first axis, the bracket comprising:
opposed prongs that are spaced along a vertical axis that is perpendicular to the first axis, wherein the opposed prongs cooperate to define a slot therebetween, wherein the slot extends along a horizontal axis that is perpendicular to the first axis and the vertical axis, wherein the slot defines a taper in a first direction from the outward side of the bracket to the fixation side of the bracket, wherein the opposed prongs each have an outer surface opposite the slot.

Aspect 2: The bracket of aspect 1, wherein the outer surface of each prong defines a groove that is configured to receive a portion of an elastic band.

Aspect 3: The bracket of aspect 2, wherein the groove is arcuate in planes perpendicular to the horizontal axis.

Aspect 4: The bracket of any one of the preceding aspects, wherein the outer surfaces of the opposed prongs converge in the first direction.

Aspect 5: The bracket of aspect 4, wherein the outer surfaces of the opposed prongs converge in the first direction at an angle from about 2 degrees to about 10 degrees.

Aspect 6: The bracket of aspect 5, wherein the outer surfaces of the opposed prongs converge in the first direction at an angle of about 4 degrees.

Aspect 7: The bracket of any one of the preceding aspects, wherein the bracket is symmetric about a horizontal plane that bisects the bracket and is parallel to or contains the horizontal axis and the first axis.

Aspect 8: The bracket of any one of aspects 1-6, wherein the outer surfaces of the bracket of the bracket both slope upwardly or both slope downwardly moving along right-to-left along a horizontal axis that is perpendicular to the first axis and the vertical axis.

Aspect 9: The bracket of any one of the preceding aspects, wherein the bracket is symmetric about a vertical plane that bisects the bracket and is parallel to or contains the vertical axis and the first axis.

Aspect 10: The bracket of any one of the preceding aspects, wherein the groove is symmetric about a vertical plane that bisects the bracket and is parallel to or contains the vertical axis and the first axis.

Aspect 11: The bracket of any one of aspects 1-8, wherein the slot is defined between opposed inner surfaces, wherein a plane bisects the inner surfaces, wherein said plane intersects the first axis at an acute angle.

Aspect 12: The bracket of aspect 11, wherein the plane intersects the first axis at an angle from about 10 to about 25 degrees.

Aspect 13: The bracket of any one of the preceding aspects, wherein the taper has an angle from about 5 degrees to about 15 degrees.

Aspect 14: The bracket of aspect 13, wherein the taper has an angle of about 10 degrees.

Aspect 15: The bracket of any one of the preceding aspects, wherein the slot has a depth along the first axis, wherein the taper is continuous along at least 80% of an entire depth of the slot.

Aspect 16: The bracket of any one of the preceding aspects, wherein the bracket comprises ceramic materials.

Aspect 17: The bracket of any one of the preceding aspects, wherein the bracket is 3D printed.

Aspect 18: A system comprising:
at least one bracket as in any one of the preceding aspects; and
a wire configured to be received within the slot.

Aspect 19: The system of aspect 18, wherein the wire has a dimension of elongation, wherein the wire is trapezoidal in cross sections perpendicular to the dimension of elongation.

Aspect 20: The system of aspect 19, wherein the wire has a profile that is configured to be complementarily received within the slot of the bracket.

Aspect 21: The system of aspect 18, wherein the wire has a dimension of elongation, wherein the wire is circular in cross sections perpendicular to the dimension of elongation.

Aspect 22: The system of aspect 21, wherein the wire is configured to be wedged within the slot to provide controlled binding between the wire and the bracket.

Aspect 23: The system of any one of aspects 18-22, wherein the wire is a first wire, and wherein the system further comprises a second wire that is configured to be received within the slot.

Aspect 24: The system of aspect 23, wherein the first wire has a first cross sectional dimension, wherein the second wire has a second cross sectional dimension that is greater than the first cross sectional dimension, wherein the first and second wires are received within the slot, wherein the first wire is positioned inwardly of the second wire, and wherein the first wire inhibits the second wire from wedging within the slot.

Aspect 25: The system of aspect 24, wherein the first and second cross sectional dimensions are diameters.

Aspect 26: The system of any one of aspects 18-25, wherein the wire is configured to apply torque to the bracket.

Aspect 27: A system comprising:
at least one bracket as in any one of aspects 1-17; and
an aligner that is configured to be coupled to the at least one bracket.

Aspect 28: The system of aspect 27, wherein the aligner is thermoformed to the at least one bracket.

Aspect 29: The system of aspect 27, wherein the aligner is 3D printed to complementarily receive the bracket.

Aspect 30: The system of any one of aspects 27-29, wherein the aligner comprises inner surfaces that are configured to be received within the slot of a bracket of the at least one bracket.

Aspect 31: The system of aspect 30, wherein the inner surfaces of the aligner that are configured to be received within the slot are configured to apply a torque to the bracket of the at least one bracket.

Aspect 32: The system of any one of aspects 27-31, wherein the outer surfaces of the opposed prongs of the at least one bracket converge in the first direction, and wherein the aligner comprises surfaces that bias against the outer surfaces of the opposed prongs of the at least one bracket to couple the aligner to the at least one bracket.

Aspect 33: The system of any one of aspects 27-32, wherein the at least one bracket comprises a plurality of brackets.

Aspect 34: A method comprising:
positioning an aligner on a bracket as in any one of aspects 1-17.

Aspect 35: The method of aspect 34, further comprising:
removing a wire from the slot of the bracket prior to positioning the aligner on the bracket.

Aspect 36: A method comprising:
positioning a wire within a slot of a bracket as in any one of aspects 1-17; and
securing the wire within the slot with an elastic band.

Aspect 37: The method of aspect 36, further comprising:
removing an aligner from the bracket prior to positioning the wire within the slot.

Aspect 38: A kit comprising:
at least one bracket as in any one of aspects 1-17; and
an aligner that is configured to be coupled to the at least one bracket.

Aspect 39: The kit of aspect 38, further comprising at least one wire.

Aspect 40: A kit comprising:
at least one bracket as in any one of aspects 1-17; and
a wire configured to be received within the slot of a bracket of the at least one bracket.

Although the foregoing invention has been described in some detail by way of illustration and example for purposes of clarity of understanding, certain changes and modifications may be practiced within the scope of the appended claims.

1. A bracket that is configured to couple to a tooth, the bracket having a fixation side and an opposed outward side that are spaced along a first axis, the bracket comprising:
opposed prongs that are spaced along a vertical axis that is perpendicular to the first axis, wherein the opposed prongs cooperate to define a slot therebetween, wherein the slot extends along a horizontal axis that is perpendicular to the first axis and the vertical axis, wherein the slot defines a taper in a first direction from the outward side of the bracket to the fixation side of the bracket, wherein the opposed prongs each have an outer surface opposite the slot.

2. The bracket of claim 1, wherein the outer surface of each prong defines a groove that is configured to receive a portion of an elastic band.

3. The bracket of claim 2, wherein the groove is arcuate in planes perpendicular to the horizontal axis.

4. The bracket of claim 1, wherein the outer surfaces of the opposed prongs converge in the first direction.

5. The bracket of claim 4, wherein the outer surfaces of the opposed prongs converge in the first direction at an angle from about 2 degrees to about 10 degrees.

6. The bracket of claim 5, wherein the outer surfaces of the opposed prongs converge in the first direction at an angle of about 4 degrees.

7. The bracket of claim 1, wherein the bracket is symmetric about a horizontal plane that bisects the bracket and is parallel to or contains the horizontal axis and the first axis.

8. The bracket of claim 1, wherein the outer surfaces of the bracket of the bracket both slope upwardly or both slope downwardly moving along right-to-left along a horizontal axis that is perpendicular to the first axis and the vertical axis.

9. The bracket of claim 1, wherein the bracket is symmetric about a vertical plane that bisects the bracket and is parallel to or contains the vertical axis and the first axis.

10. The bracket of claim 1, wherein the groove is symmetric about a vertical plane that bisects the bracket and is parallel to or contains the vertical axis and the first axis.

11. The bracket of claim 1, wherein the slot is defined between opposed inner surfaces, wherein a plane bisects the inner surfaces, wherein said plane intersects the first axis at an acute angle.

12. The bracket of claim 11, wherein the plane intersects the first axis at an angle from about 10 to about 25 degrees.

13. The bracket of claim 1, wherein the taper has an angle from about 5 degrees to about 15 degrees.

14. The bracket of claim 13, wherein the taper has an angle of about 10 degrees.

15. The bracket of claim 1, wherein the slot has a depth along the first axis, wherein the taper is continuous along at least 80% of an entire depth of the slot.

16. The bracket of claim 1, wherein the bracket comprises ceramic materials.

17. The bracket of claim 1, wherein the bracket is 3D printed.

18. A system comprising:
at least one bracket as in claim 1; and
a wire configured to be received within the slot.

19. (canceled)

20. (canceled)

21. (canceled)

22. (canceled)

23. (canceled)

24. (canceled)

25. (canceled)

26. (canceled)

27. A system comprising:
at least one bracket as in claim 1; and
an aligner that is configured to be coupled to the at least one bracket.

28. (canceled)

29. (canceled)

30. (canceled)

31. (canceled)

32. (canceled)

33. (canceled)

34. A method comprising:
positioning an aligner on a bracket as in claim 1.

35. (canceled)

36. (canceled)

37. (canceled)

38. (canceled)

39. (canceled)

40. (canceled)
